(19) United States
(12) Patent Application Publication
(10) Pub. No.: US 2005/0015568 A1
(43) Pub. Date: Jan. 20, 2005

(54) Method and system of writing data in a multiple processor computer system

(76) Inventors: Karen L. Noel, Pembroke, NH (US); Wendell B. Fisher JR., Nashua, NH (US); Gregory H. Jordan, Hollis, NH (US); Christian Moser, Helsinki (FI)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/619,697

(22) Filed: Jul. 15, 2003

(51) Int. Cl. G06F 12/08

(52) U.S. Cl. 711/206; 711/147

(57) ABSTRACT

A method and system for executing a first instance of a program on a first processor in computer system having multiple processors (wherein the program refers to a virtual memory address in a page table to obtain a pointer to a memory location to write writable data), executing a second instance of a program on a second processor in the computer (wherein the second instance of the program refers to a virtual memory address in a page table to obtain a pointer to a memory to a memory location to write the writable data), wherein the VMA referred to by each of the first and second instance of the program is the same, wherein the VMA referred to by the first instance of the program points to a memory coupled to the first processor, and wherein the VMA referred to by the second instance of the program points to a memory coupled to the second processor.

### BACKGROUND

High performance computer systems may utilize multiple processors to increase processing power. The workload may be divided and distributed among the processors thereby reducing execution time and increasing performance. An architectural model for high performance multiple processor system may be a Non-Uniform Memory Access (NUMA) system. Under the NUMA model, system resources, such as processors and random access memory, may be segmented into groups referred to as Resource Affinity Domains (RADs). Thus, each RAD may comprise one or more processors and assigned physical memory. A processor in a RAD may access the memory assigned to its RAD, referred to as local memory, or a processor may access memory assigned to other RADs, referred to as non local memory. Referencing memory on other RADs may carry a performance penalty.

Thus, in NUMA systems, the memory may be shared across the multiple processors and programs executing on those processors. Thus, there may be instances where multiple programs may need to access the same memory location, e.g., read and write a global variable such as a counter. Because some writes may be based on the previous value at the memory location, memory locations to be written, writable memory, cannot be duplicated across multiple RADs. Further, there may be performance penalties for writing the non-local memory, and there may also be latencies associated with multiple programs and/or processors attempting to substantially simultaneously write the same memory locations. The latencies may derive from waiting for other programs to complete their access, and the overhead associated coherence protocols for the memory.

### SUMMARY

The problems noted above may be solved in large part by a method and system of writing data in a multiple processor computer system. In one exemplary embodiments, a method comprises: executing a first instance of a program on a first processor in a computer system having multiple processors (wherein the program refers to a virtual memory address in a page table to obtain a pointer to a memory location to write writable data), executing a second instance of a program on a second processor in the computer (wherein the second instance of the program refers to a virtual memory address in a page table to obtain a pointer to a memory to a memory location to write the writable data), wherein the VMA referred to by each of the first and second instance of the program is the same, wherein the VMA referred to by the first instance of the program points to a memory coupled to the first processor, and wherein the VMA referred to by the second instance of the program points to a memory coupled to the second processor.

### BRIEF DESCRIPTION OF THE SYSTEM AND DRAWINGS

A better understanding of the disclosed systems and methods may be obtained by reference to the following drawings, in which:

FIG. 1 illustrates a computer system in accordance with embodiments of the invention; and

FIG. 2 illustrates, in block diagram form, at least one mechanism to duplicate writable memory locations in accordance with embodiments of the invention.

While the invention is susceptible to various modifications and alternative forms, embodiments of the invention are shown by way of example in the drawings and described herein. It should be understood, however, that the drawings and detailed description are not intended to limit the invention to the particular form disclosed, but on the contrary, the invention is to cover all modifications, equivalents and alternatives falling within the spirit and scope of the present invention as defined by the appended claims.

### NOTATION AND NOMENCLATURE

Certain terms are used throughout the following description and claims to refer to particular components and systems. Computer and software companies may refer to components by different names. This document does not intend to distinguish between components and systems that differ in name but not function.

In the following discussion and in the claims, the terms “including” and “comprising” are used in an open-ended fashion, and thus should be interpreted to mean “including, but not limited to . . . ”. Also, the term “couple” or “couples” is intended to mean either an indirect or direct electrical connection. Thus, if a first device couples to a second device, that connection may be through a direct electrical connection, or through an indirect electrical connection via other devices and connections.

### DETAILED DESCRIPTION

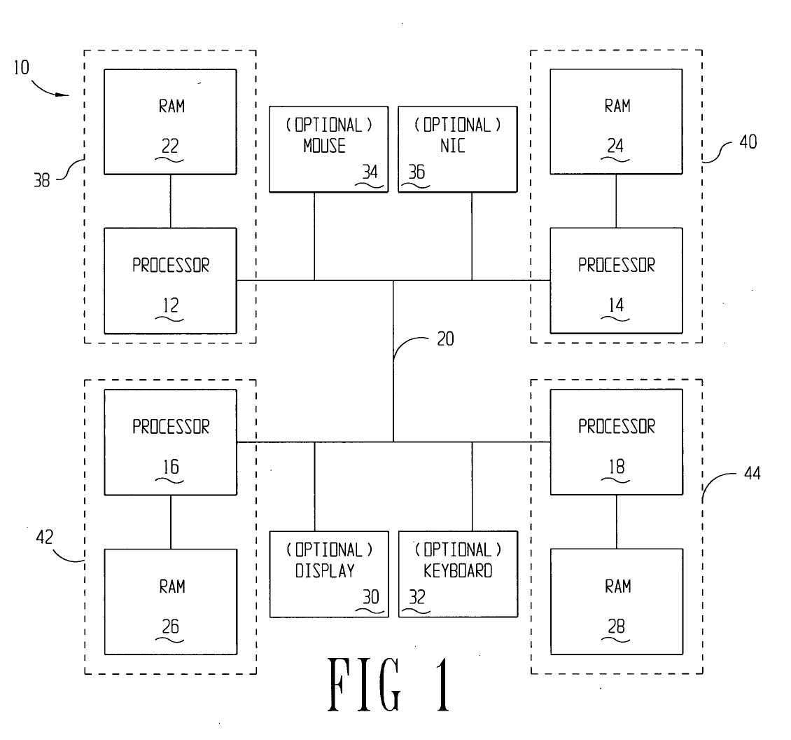

FIG. 1 illustrates an exemplary computer system 10. Embodiments of the invention may be directed to computer systems having multiple processors, and thus FIG. 1 illustrates four processors 12, 14, 16 and 18; however, any number of processors may be used. The processors 12, 14, 16 and 18 may couple to each other, and possibly other computer system 10 components, by way of an address/data bus 20. The processors 12, 14, 16 and 18 may comprise any suitable processor, or array of processors, e.g., processors available from Hewlett-Packard, Intel and AMD. Computer system 10 may also comprise random access memory (RAM) 22 coupled to processor 12, RAM 24 coupled to processor 14, RAM 26 coupled to processor 16, and RAM 28 coupled to processor 18. RAM 22, 24, 26 and 28 may provide a working area from which the processors 12, 14, 16 and 18 may read and execute commands, and temporarily read and store data.

Still referring to FIG. 1, computer system 10 may optionally couple to a display device 30 upon which data or other information generated by the computer system 10 may be displayed. The display device 30 may comprise any suitable display or monitor, such as a cathode ray tube (CRT) based display or a liquid crystal display (LCD). Further, computer system 10 may optionally couple to a keyboard 32 and/or mouse 34. Optional keyboard 32 may be used for inputting commands and data, and may comprise any available full or partial data entry device or keypad. Likewise, optional mouse 34 may be used for cursor control functions. In at least some embodiments, the computer system 10 may be operated as a server, which may mean that the device is placed in a data center and dedicated to specific tasks. In server operation, a plurality of servers may be placed within a rack or enclosure, and in such a circumstance the optional display, keyboard and mouse may not be used. The computer system 10 may also optionally comprise a network interface card (NIC) 36 coupled by way of the address/data bus 20. The NIC 36 may allow the computer system 10 to couple to other network devices, such as other computers, switches and routers.

Each processor and its attached RAM may form functional units. Thus, processor 12 and RAM 22 may form a functional unit 38. Processor 14 and RAM 24 may form a functional unit 40. Processor 16 and RAM 26 may form a functional unit 42. Processor 18 and RAM 28 may form a functional unit 44.

At least some embodiments of the invention may be computer systems with multiple processors operated under an architecture known as the non-uniform memory access (NUMA) model. Under the NUMA model, system resources such as processors and RAM may be segmented into functional units, which the NUMA model may designate as resource affinity domain (RADs). Thus, the functional units 38, 40, 42 and 44 of FIG. 1 may be referred to as RADs within a NUMA system.

Within each RAD, programs may execute on the processor and these programs may access memory locations, either in memory within the RAD (local memory) or memory outside the RAD (non-local memory). While some of these programs may be user programs, such as word processors and database programs, the category of programs executed on a processor may also include operating system programs. In accordance with embodiments of the invention, at least some of the operating system programs may be replicated from long-term storage devices (not shown) to portions of the RAM in each RAD designated as read-only. Portions of the memory in each RAD designated as read-only should not be confused with the category of devices known as read-only memory (ROM). Thus, rather than copy the operating system programs each time from a long-term storage device, or access the operating system programs from a single shared location, each RAD may execute the operating system from replicated operating system programs in local memory. Having replicated portions of the operating system in each RAD may not present an access problem inasmuch as these portions may be designed as read-only.

The inventors of the present specification have found that at least some writable memory locations may be duplicated among RADS, with programs in each RAD accessing only their local copy. Stated otherwise, for some otherwise global variables in a multiple processor computer system, there need not be a single master copy stored in one location. Thus, while a RAD may implement a cache coherence protocol between cache and RAM within the RAD, the coherence protocol need not extend to maintain coherence among the various RADS with respect to those duplicated writable memory areas. In accordance with at least some embodiments of the invention, duplicating writable memory locations among RADs may find use in connection with operating system programs; however, duplicating writable memory locations may equivalently find application with other programs as well.

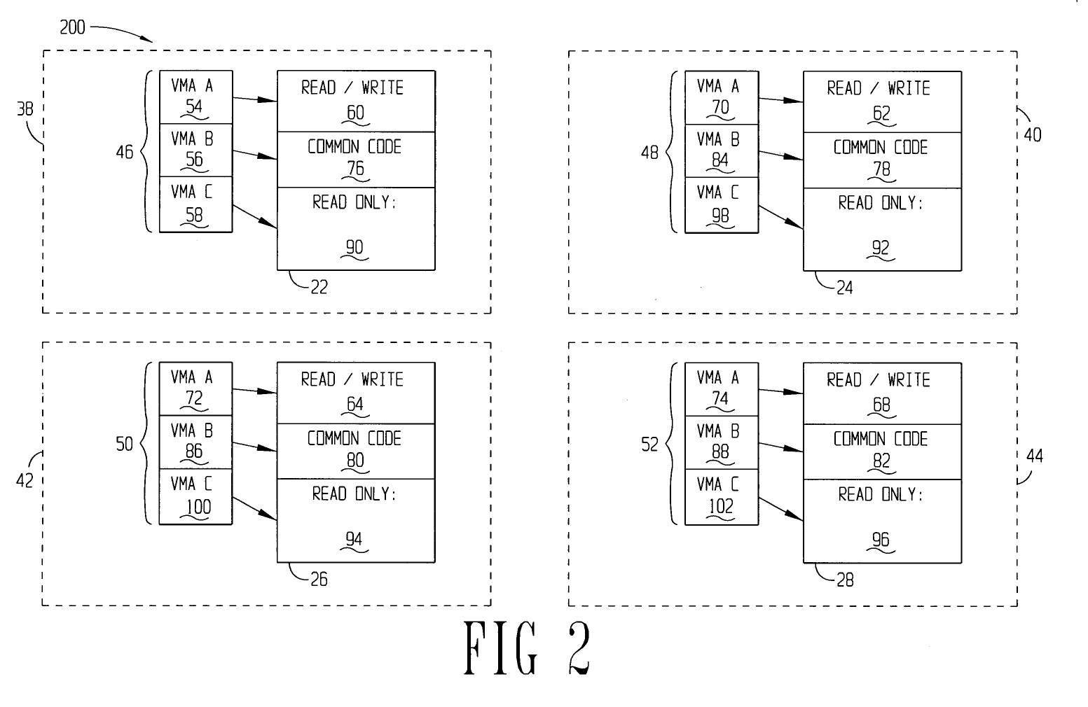

FIG. 2 illustrates, in block diagram form, a system with duplicate writable memory locations in accordance with embodiments of the invention. Because the illustration of FIG. 2 may be related to the computer system 10 of FIG. 1, FIG. 2 illustrates four functional units or RADs 38, 40, 42 and 44; however, any number of RADs may be used. Each of the RADs 38, 40, 42 and 44 may have associated therewith a page table 46, 48, 50 and 52 respectively. A page table may be a table, possibly stored in RAM or cache memory of a processor, that may provide virtual memory address (VMA) to physical memory address (PMA) translation. The VMA may be a virtual address used by user and/or operating system programs to access physical memory. In accordance with embodiments of the invention, the VMAs may be common among the RADS, but the VMAs may map to different physical addresses depending upon RAD membership.

Consider for purposes of explanation the page table 46 and RAM 22 within RAD 38. Each VMA 54, 56 and 58 within the page table 46 may map or point to physical addresses within the RAM 22. In this particular example, RAM 22 is within the RAD along with processor 12 (FIG. 1). Thus, page table 46 may provide address translations to the physical memory within RAM 22. It follows that exemplary page table 48 may provide address translations to RAM 24 in RAD 40. Exemplary page table 50 may provide address translations to RAM 26 in RAD 42. Likewise, exemplary page table 52 may provide address translations to RAM 28 in RAD 44.

In accordance with embodiments of the invention, memory within a RAD may take a plurality of designations, such as: read/write, common code, and read-only. That is, while the memory within each RAD may be RAM, portions of that RAM may take various designations to fulfill purposes within the RAD. Memory within each designation may be broken down into subgroups, which may be referred to as pages. Read/write pages 60, 62, 64 and 68 may thus contain programs and data utilized by processes needing to read and write data. Each VMA A 54, 70, 72 and 74, though having the same virtual address, may comprise a pointer to physical address to read/write pages 60, 62, 64 and 68 respectively.

A second designation of RAM within a RAD may be “common code.” It may be within the common code pages that replicated portions of the operating system are stored. The operating system may thus execute from the common code portion of the RAM within each RAM. In the exemplary system 200, each VMA B 56, 84, 86 and 88, though having the same virtual address, may comprise a pointer to physical address for common code pages 76, 78, 80 and 82 respectively.

Yet another designation of RAM within a RAD may be read-only, which should not be confused with read-only memory (ROM) devices. Read-only pages 90, 92, 94 and 96 may contain static data that may be utilized by programs, such as replicated portions of the operating system in the common code pages. Each VMA C 58, 98, 100 and 102, though having the same virtual address, may comprise a pointer to physical address for read-only pages 90, 92, 94 and 96 respectively. It is noted that the common code pages 76, 78, 80 and 82, though storing replicated portions of operating system programs, may likewise be designated as read-only.

The inventors of the present specification have found that there may be read and write variables, whether global or otherwise, in a computer system that need not necessarily have only a single master copy in the shared memory areas. Thus, in accordance with embodiments of the invention, some read/write memory locations may be duplicated among multiple RADs. As an example only, operating systems designed and constructed in accordance with embodiments of the invention may implement performance counters. The performance counters may be incremented each time a particular event takes place, and/or a particular code path of the operating system is executed. An exemplary set of code paths that may be tracked are code paths associated with disk drive access or allocation of pages in memory. Alternatively, there may be a look-aside list header for data structures, such as process control blocks, which may be stored in the portion of memory designated as read/write, but which need not have a single master copy across the shared memory area. The look-aside list header may thus provide, by accessing the same virtual memory address within each RAD, a pointer to the locations in physical memory where the process control blocks may be stored. The following description will be based on the exemplary performance counters; however, this is only for convenience of the discussion.

Referring simultaneously to FIGS. 1 and 2, consider an operating system program executing on processor 12 in RAD 38. As the operating system program executes, it may at times traverse a code path for which a performance counter is maintained. In this situation and in these exemplary embodiments directed to performance counters, a counter associated with the code path of interest, possible stored in read/write pages 60, may be incremented. To access the counter, the operating system program may first make reference to the page table 46, and in particular the VMA A 54. VMA A 54 may thus point to a particular portion of read/write area 60 which contains the exemplary counter value. Using the pointer to the local memory, the operating system program may thus read the value (to obtain the previous value) and write a new incremented value to the memory location.

Now consider an operating system program executing on processor 14 in RAD 40 simultaneously with the operating system program executing on processor 12 in RAD 38. The operating system executing in RAD 40 may traverse the same code path (in the replicated portion of the operating system) for which a performance counter is maintained. When the particular code path is traversed, the operating system program in RAD 40 may need to update a counter. A first step in the process of updating the counter may be a reference to page table 48, and in particular VMA A 70. VMA A 70 may thus point to a particular portion of the read/write area 62 which contains the exemplary counter value for RAD 40. Using the pointer to the memory local to RAD 40, the operating system program may read the value (to obtain the previous value) and write a new value to the memory location. A similar discussion may follow for RADs 42 and 44. Because the page tables and VMAs in each RAD may point to a portion of local memory storing the counter value, however, the respective count values may be maintained in local memory.

In the specific example of performance counters, the count values from each of the RADs may be read, accumulated, and possibly cleared, by a program specifically designed for that task. The program that periodically reads the counters may suffer the performance penalty associated with non-local RAD access, but each operating system program may update the respective count value without the performance penalty. Updating count values may take place more frequently than accumulating those values from the various RADs in a computer system, and thus there may be performance increases over systems where only a single master copy of each count value is maintained. Accessing of the count values in different RADS for accumulation purposes may take place by having additional virtual memory addresses that map, in a read-only fashion, to count values in read/write areas 60, 62, 64 and 68. Thus, accumulation may take place by a program executing within a RAD accessing the various count values (possibly with the performance penalty associated with non-local accesses) by accessing the VMAs that point to each count value.

Numerous variations and modifications will become apparent to those skilled in the art once the above disclosure is fully appreciated. It is intended that the following claims be interpreted to embrace all such variations and modifications.

1. A method comprising:
executing a first instance of a program on a first processor in a computer system having multiple processors, and wherein the program refers to a virtual memory address (VMA) in a page table to obtain a pointer to a memory location to write writable data;
executing a second instance of the program on a second processor in the computer system, and wherein the second instance of the program refers to a virtual memory address (VMA) in a page table to obtain a pointer to a memory location to write the writable data; and
wherein the VMA referred to by each of the first and second instance of the program is the same, and wherein the VMA referred to by the first instance of the program points to a memory coupled to the first processor, and wherein the VMA referred to by the second instance of the program points to a memory coupled to the second processor.

2. The method as defined in claim 1 further comprising:
wherein the executing the first instance step further comprises executing the first instance of the program in a first functional unit of the multiple processor system;
wherein the executing the second instance step further comprises executing the second instance of the program in a second functional unit of the multiple processor system; and
wherein the first and second instances of the program are replicated versions of the same program.

3. The method as defined in claim 1 wherein the program is an operating system program, and wherein the writable data further comprises a performance counter count value.

4. The method as defined in claim 3 further comprising:
reading the count value from the memory coupled to the first processor;
reading the count value from the memory coupled to the second processor; and
combining the count values.

5. The method as defined in claim 4 wherein the performance counter count value is a number representing a number of page allocations in memory.

6. The method as defined in claim 4 wherein the performance counter count value is a number representing a number of disk accesses.

7. The method as defined in claim 1 wherein the program is an operating system program, and wherein the writable data further comprises a look-aside list header for process control blocks.

8. A computer readable media storing programs executable by a processor that, when executed, perform the following steps:
accessing a read/write variable in a computer system having a plurality of functional units, each of the plurality of functional units having a processor and a random access memory (RAM) coupled to the processor; the accessing by
referring to a virtual memory address (VMA) in a page table to locate the read/write variable, wherein the VMA in each functional unit is the same, and wherein the VMA in each functional unit contains a pointer to RAM within its functional unit.

9. The computer readable media as defined in claim 8 wherein the steps performed by the programs further comprise:
reading each of the read/write variables throughout the computer system;
combining the read/write variables; and
writing the combined read/write variables to a single location within the computer system.

10. The computer readable media as defined in claim 9 wherein the combining step further comprises adding the values of each of the read/write variables.

11. The computer readable media as defined in claim 9 wherein the steps performed by the programs further comprise clearing each of the read/write variables.

12. A computer system comprising:
a first processor coupled to a first memory, the first processor and first memory forming a first functional unit;
a second processor coupled to a second memory and forming a second functional unit, the second processor coupled to the first processor;
a page table in the first functional unit having a virtual memory address (VMA) for a read/write variable, the VMA in the page table of the first functional unit pointing to the first memory; and
a second page table in the second functional unit having a VMA for the read/write variable, the VMA in the page table of the second functional unit pointing to the second memory.

13. The computer system as defined in claim 12 further comprising:
a first replicated program executing on the first processor, the first replicated program writing the read/write variable at a location indicated by the VMA in the page table of the first functional unit;
a second replicated program executing on the second processor, the second replicated program writing the read/write variable at a location indicated by the VMA in the page table of the second functional unit; and
wherein the first and second replicated programs are the copies of a same program.

14. The computer system as defined in claim 13 wherein the first and second replicated programs are copies of an operating system program, and wherein the read/write variable is a counter that indicates a number of executions of a code path of the operating system program.

15. The computer system as defined in claim 13 wherein the first and second replicated programs are copies of an operating system program, and wherein the read/write variable is a look-aside list header for process control blocks.

16. A computer system comprising:
a first means for executing programs coupled to a first means for storing programs and data, the first means for executing and first means for storing forming a first functional unit;
a second means for executing programs coupled to a second means for storing programs and data, and forming a second functional unit, the second means for executing coupled to the first means for executing;
a page table in the first functional unit having a virtual memory address (VMA) for a read/write variable, the VMA in the page table of the first functional unit pointing to the first means storing; and
a second page table in the second functional unit having a VMA for the read/write variable, the VMA in the page table of the second functional unit pointing to the second means for storing.

17. The computer system as defined in claim 16 further comprising:
a first replicated program executing on the first means for executing, the first replicated program writing the read/write variable at a location indicated by the VMA in the page table of the first functional unit;
a second replicated program executing on the second means for executing, the second replicated program writing the read/write
variable at a location indicated by the VMA in the page table of the second functional unit; and
wherein the first and second replicated programs are the copies of a same program.

18. The computer system as defined in claim 17 wherein the first and second replicated programs are copies of an operating system program, and wherein the read/write variable is a counter that indicates a number of executions of a code path of the operating system program.

19. The computer system as defined in claim 17 wherein the first and second replicated programs are copies of an operating system program, and wherein the read/write variable is a look-aside list header for process control blocks.
